(19) United States
(12) Patent Application Publication
(10) Pub. No.: US 2012/0072830 A1
(43) Pub. Date: Mar. 22, 2012

(54) Cross-platform data displaying system and method thereof

(75) Inventors: Chaucer Chiu, Taipei (TW); Hua Bei Zhao, Shanghai (CN)

(73) Assignee: INVENTEC CORPORATION, Taipei (TW)

(21) Appl. No.: 12/928,591

(22) Filed: Dec. 14, 2010

(30) Foreign Application Priority Data
Sep. 21, 2010 (TW) 099131969

(51) Int. Cl. G06F 17/00

(52) U.S. Cl. 715/235

(57) ABSTRACT

A cross-platform data displaying system and the method thereof are provided. The system and method establish a tag translating list, translate the original tags and control characters in displayed data into target tags, write the display elements and target tags into an output file, and output the output file for display. By completing the above procedure, the disclosed system and method enable program data to display properly on different platforms.

### BACKGROUND OF THE INVENTION

1. Field of Invention

The invention relates to a data displaying system and the method thereof.

In particular, the invention relates to a data displaying system for cross-platform data display and the method thereof.

2. Related Art

Through a long history of information technology development, different operating system (OS) and data processing platforms have their distinctive features and data processing formats. For example, Microsoft Windows, WinCE for embedding systems, and Linux of various vendors all have their own program development and displaying methods. Take programs developed under Microsoft platform using the C++ programming language as an example. Using the MFC database, one can develop programs that are highly compatible with the Windows OS. However, when the program are implanted into a different OS or data processing platform, the View routine in the program may not operate normally due to different supported programming languages. In this case, the program data cannot be displayed properly.

In summary, the prior art always has the problem that the View routine developed using a specific programming language may not be able to run on all devices or platforms. Since most OS's and data processing platforms support HTML data display, it is necessary to provide an improved technique on such basis to solve the problem.

### SUMMARY OF THE INVENTION

In view of the foregoing, the invention provides a cross-platform data displaying system and the method thereof.

The disclosed cross-platform data displaying system comprises: a receiving module for receiving display data that include at least one control character, at least one display element, and an original tag associated with each of the display elements; a translating module with a pre-established tag translating list that includes at least one original tag, at least one control character, and target tags, wherein each of the target tags is uniquely corresponding to the one original tag or control character, and for translating the original tags and control characters in the display data into the corresponding target tags according to the tag translating list and writing the display elements and target tags into an output file; and an outputting module for outputting the output file for display.

The disclosed cross-platform data displaying method comprises the steps of: pre-establishing a tag translating list that includes at least one original tag, at least one control character, and target tags, wherein each of the target tags is uniquely corresponding to one original tag or control character; receiving display data that include at least one control character, at least one display element, and original tags corresponding to the display elements; translating the original tags and control characters in the display data into the corresponding target tags according to the tag translating list; writing the display elements and the target tags into an output file; and outputting the output file for display.

As described above, the disclosed system and method differ from the prior art in that the invention has a pre-established tag translating list and is capable of translating the original tags and control characters in the display data into target tags, writing the display elements and target tags into the output file, and then outputting the output file for display.

Using the disclosed techniques, the invention is capable of displaying program data properly on different platforms.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed cross-platform data display system;

FIG. 2 is a flowchart of the disclosed cross-platform data display method;

FIG. 3A is a schematic view of the screen with display data according to an embodiment of the invention;

FIG. 3B is a schematic view of display data in the embodiment;

FIG. 3C is a schematic view of the tag translating list in the embodiment; and

FIG. 4 is a schematic view of the output file in the embodiment.

### DETAILED DESCRIPTION OF THE INVENTION

The present invention will be apparent from the following detailed description, which proceeds with reference to the accompanying drawings, wherein the same references relate to the same elements.

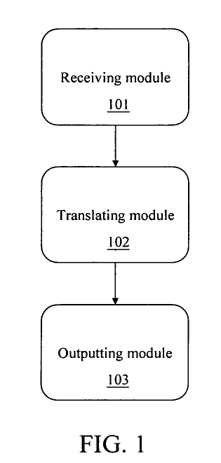

Please refer to FIG. 1, a block diagram of the disclosed cross-platform data displaying system. It includes a receiving module 101, a translating module 102, and an outputting module 103.

The receiving module 101 receives display data. The display data include at least one control character, at least one display element, and original tags corresponding to each of the display elements. Take a dictionary program as an example, a dictionary program may include dictionary entries with explanation and usage of words. Such dictionary entries are a type of display data. When the dictionary program is programmed using specific programming language, such as MFC of C++, the display data of the dictionary program may contain original tags and display elements, wherein the original tags is to allow View routine in the dictionary program to position different types of display elements, and the display elements are the content such as syntactical functions, explanations, etc. The display data is then interpreted and displayed by the View routine of the dictionary program. Although dictionary entries of a dictionary program are used in this specification as an example of display data, the display data can be any data to be displayed by a viewing routine. It should be emphasized that the original tags of the display data further correspond to the display styles in a CSS file. The display styles can be the font, color, control contents, or other styles of a display element.

The translating module 102 has a pre-established tag translating list. The tag translating list includes at least one original tag, at least one control character, and target tags, wherein each of the target tags is uniquely corresponding to one original tag or control character. The tag translating list includes the original tags for the View routine to position the display elements, such as the control characters of space bar, return, and skip, and HTML target tags corresponding to the original tags and control characters. The translating module 102 translates the original tags and control characters in the display data into the corresponding target tags according to the tag translating list. The display elements and the target tags are written into an output file in the format of HTML code. For example, suppose the data content of an original tag in the display data is “title.” The HTML target tag thereof is “<title> . . . </title>.” Suppose a control character is the return character. Then the translated HTML target tag is “<br />.” Besides, during the display data translating process, the translating module 102 also takes the display style in the CSS document as a display attribute and embeds it in the target tag.

The outputting module 103 outputs the output file for display.

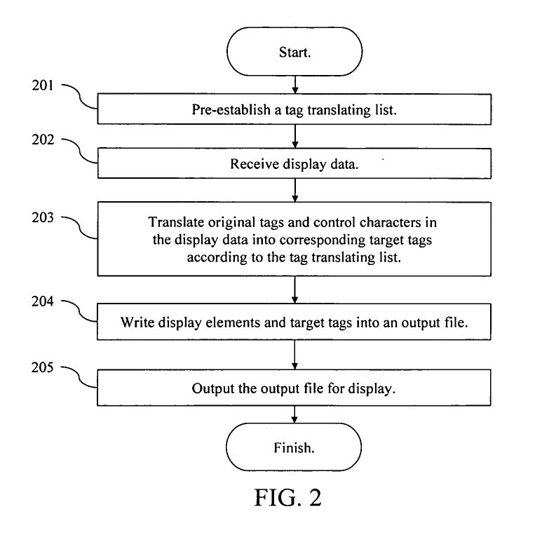

Please refer to FIG. 2 for a flowchart of the disclosed cross-platform data displaying method.

First, a tag translating list is established in advance (step 201). The tag translating list includes at least one original tag, at least one control character, and at least one target tag, wherein each of the target tags is uniquely corresponding to one original tag or control character. The tag translating list includes the original tags for the View routine to position the display elements, such as the control characters of space bar, return, and skip, and HTML target tags corresponding to the original tags and control characters. Suppose the data content of an original tag in the display data is “title,” then the HTML target tag thereof is “<title> . . . </title>.” Suppose a control character is the return character. Then the translated HTML target tag is “<br />.”

Afterwards, display data are received (step 202). The display data include at least one control character, at least one display element, and original tags corresponding to each of the display elements. The display data refer to the data of a program to be displayed to its user. For example, a dictionary program may include dictionary entries with explanations and usages of words. Such dictionary entries are a type of display data. When the dictionary program is programmed using specific programming language, such as MFC of C++, the display data of the dictionary program may contain original tags and display elements, wherein the original tags is to allow View routine in the dictionary program to position different types of display elements, and the display elements are the content such as syntactical functions, explanations, etc. The display data is then interpreted and displayed by the View routine of the dictionary program. Although translation data of a translating program are used in this specification as an example, the display data can be any data to be displayed by a viewing routine. It should be emphasized that the original tags of the display data further correspond to the display styles in a CSS file. The display styles can be the font, color, control contents, or other styles of a display element.

Afterwards, the original tags and control characters in the display data are translated into the corresponding target tags according to the tag translating list (step 203). The display elements and the target tags are written into an output file in the format of HTML code (step 204). Finally, the output file is output for display (step 205).

It should be mentioned that during the display data translating process, the translating module 102 also uses the display style in the CSS document as a display attribute and embeds it in the target tag. Therefore, the original display style can be preserved to be displayed on different platforms.

In the following, the cross-platform displaying process of using the invention is used to explain how it works.

First, before the translating program is moved to another platform to display, it first establishes a tag translating list. The tag translating list includes at least one original tag, at least one control character, and at least one target tag, wherein each of the target tags is uniquely corresponding to one original tag or control character.

The tag translating list includes the original tags for the View routine to position the display elements, such as the control characters of space bar, return, and skip, and HTMP target tags corresponding to the original tags and control characters.

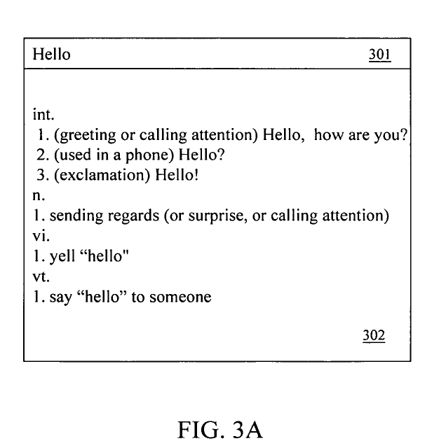

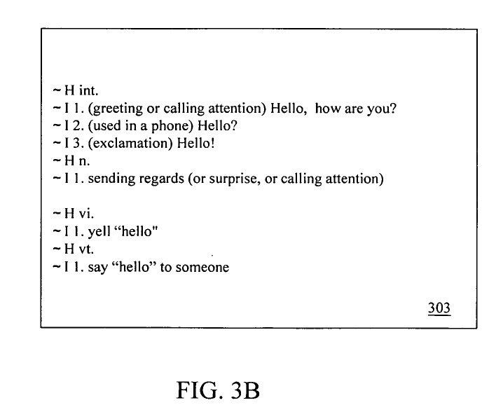

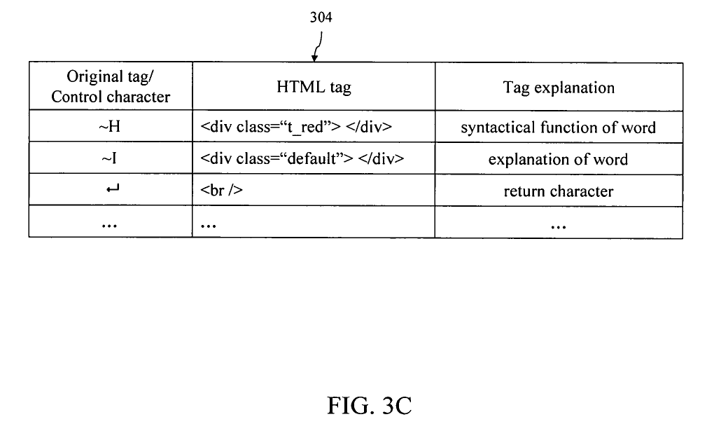

Please refer to FIG. 3A. Suppose there is set of display data for the word 301 “Hello.” Through the interpretation of the View routine, the data are displayed as shown in the screen 302, showing the syntactical functions and explanations of the word “Hello.” Suppose the display data before the interpretation are as shown in FIG. 3B. The display data 303 include such original tags as “˜H” meaning syntactical functions and “˜I” meaning explanations, such display elements of explanations as “1. (greeting or calling attention) Hello, how are you?”, “2.(used in phone call) Hello?”, and so on, and return control characters (not shown). When the View routine of the dictionary program receives the display data 303, it first translates the original tags “˜H” and “˜I” and control characters into HTML target tags according to the tag translating list. As shown in FIG. 3C, the tag translating list 304 includes the original tags, control characters, and the corresponding HTML target tags.

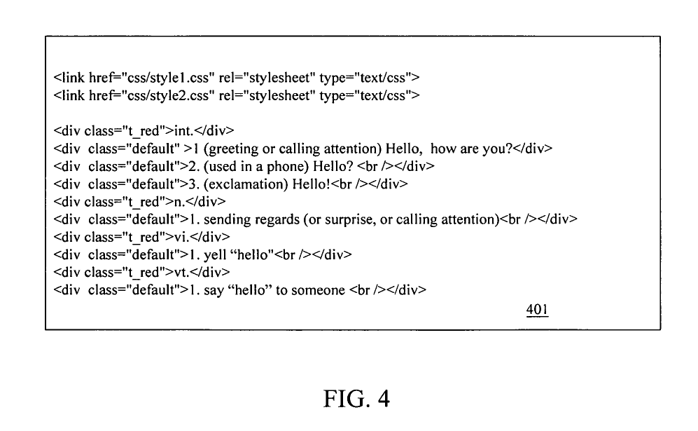

It should be mentioned that the original tags of the display data 303 further have a display style in the CSS file. Therefore, during the translating process, the display style can be embedded in the HTML target tag as a display attribute. Suppose “˜H” stands for syntactical function in the original tag and is displayed in red. Then the translated HTML target tag is “<div class=”t_red“> . . . </div>”. Here t_red can be a display style defined in CSS. When the original tags of the display data are all translated into HTML target tags, the HTML target tags and the display elements are written into an output file 401, as shown in FIG. 4. Since the output file is in the format of HTML code, the output file can be displayed on the browsers of different platforms. The invention thus achieves the goal of cross-platform data display.

In summary, the invention differs from the prior art in that it first establishes a tag translating list and translates the original tags and control characters in the display data into the target tags. The display elements and the target tags are written into an output file, and then is outputted for display. This technique solves the problem in the prior art that the View routine developed using a specific programming may not run on all devices or platforms. The invention therefore enables program data to display properly across different platforms.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A cross-platform data displaying system, comprising:
a receiving module for receiving display data that include at least one control character, at least one display element, and an original tag associated with each of the display elements;
a translating module with a pre-established tag translating list that includes at least one original tag, at least one control character, and target tags, wherein each of the target tags is uniquely corresponding to one original tag or control character, and for translating the original tags and control characters in the display data into the corresponding target tags according to the tag translating list and writing the display elements and target tags into an output file; and
an outputting module for outputting the output file for display.

2. The cross-platform data displaying system of claim 1, wherein each of the original tags corresponds to one display style in a CSS file, the translating module translates the display style into a display attribute and embeds the display attribute into the target tag.

3. The cross-platform data displaying system of claim 1, wherein the target tag is an HTML tag.

4. The cross-platform data displaying system of claim 1, wherein the output file is an HTML code.

5. A cross-platform data displaying method, comprising the steps of:
pre-establishing a tag translating list that includes at least one original tag, at least one control character, and target tags wherein each of the target tags is uniquely corresponding to one original tag or control character;
receiving display data that include at least one control character, at least one display element, and original tags corresponding to the display elements;
translating the original tags and control characters in the display data into the corresponding target tags according to the tag translating list;
writing the display elements and the target tags into an output file; and
outputting the output file for display.

6. The cross-platform data displaying method of claim 5, wherein each of the original tag corresponds to one display style in a CSS file, and the step of translating the original tags and control characters in the display data into the corresponding target tags according to the tag translating list further includes the step of translating the display style into a display attribute and embedding the display attribute into the target tag.

7. The cross-platform data displaying method of claim 5; wherein the target tag is an HTML tag.

8. The cross-platform data displaying method of claim 5, wherein the output file is an HTML code.
